(19) United States
(12) Patent Application Publication
(10) Pub. No.: US 2004/0146445 A1
(43) Pub. Date: Jul. 29, 2004

(54) Methods, compositions, and bi-functional catalysts for synthesis of silica, glass, silicones

(76) Inventors: Daniel E Morse, Santa Barbara, CA (US); Yan Zhou, Goleta, CA (US); Galen D Stucky, Goleta, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/478,118

(22) PCT Filed: Apr. 4, 2001
(86) PCT No.: PCT/US01/11481

(51) Int. Cl. C01B 33/12

(52) U.S. Cl. 423/335; 65/17.2

(57) ABSTRACT

Unique catalyst compositions and methods of using the compositions wherein the catalysts include a nucleophilic functionality and a hydrogen-bonding acceptor group and are used in the synthesis of silica, glass, silicones, and polymetallooxanes at low temperatures and at about neutral pH.

### CROSS REFERENCE WITH RELATED APPLICATIONS

This application claims the benefit of U.S. Provisional Application Serial No. 60/194568 filed Apr. 4, 2000, and is fully incorporated herein by reference.

### STATEMENT REGARDING FEDERALLY SPONSORED RESEARCH OR DEVELOPMENT

This invention was made with Government support under Grant No. DAAH04-96-1-0443, awarded by the Army Research Office. The Government has certain rights in this invention.

### BACKGROUND OF THE INVENTION

1. Field of the Invention

The present invention relates to a process of synthesizing silica, glass, silicones, and polymetallooxanes, and to the catalytic composition used.

2. Description of Related Art

Silicon, the second most abundant element on Earth, is widely used in the manufacture of siloxane-based semiconductors, glasses, ceramics, plastics, elastomers, resins, mesoporous molecular sieves and catalysts, optical fibers and coatings, insulators, moisture shields, photoluminescent polymers, and cosmetics [Auner, N. and Weis., J. (1998) Organosilicon Chemistry III: From Molecules to Materials, Wiley W C H; Auner, N. and Weis., J. Organosilicon Chemistry IV: From Molecules to Materials, Wiley W C H (in press); and Ball, P. (1997) Made to Measure: New Materials for the 21^{st} Century, Princeton University Press, Princeton, N.J., USA]. The manufacture of these materials typically requires high temperatures or the use of caustic chemicals.

By contrast, the biological production of amorphous silica, the simplest siloxane [(SiO₂)ₙ], is accomplished under mild physiological contitions, producing a remarkable diversity of exquisitely structured shells, spines, fibers, and granules in many protists, diatoms, sponges, molluscs and higher plants (Simpson, T. L. and Volcani, B. E. (1981) Silicon and Siliceous Structures in Biological Systems, Springer-Verlag; and Voronkov, M. G., Zelchan, G. I. and Lukevits, E. J. (1997) Silicon and Life (2^{nd} ed.), Zinatne Publishing, Vilnius, Lithuania]. These biologically produced silicas exhibit a genetically controlled precision of nanoscale architecture that, in many cases, exceeds the capabilities of present-day human engineering. Furthermore, the biological production of siloxanes occurs on an enormous scale globally, yielding gigatons per year of silica deposits on the floor of the ocean. Diatomaceous earth (composed of the nanoporous skeletons of diatoms) is mined in great quantities from the vast primordial deposits of this biogenic silica.

Hildebrand , et al., made a significant breakthrough by cloning and characterizing the cDNA encoding the first silicic-acid [Si(OH)₄] transporter to be unequivocally identified [Hildebrand, M., Volcani, B. E., Gassman, W., & Schroeder, J. I. (1997) Nature 385, 688-689]. They showed, by analysis of the encoded protein and by injection of the mRNA (synthesized in vitro from the cloned cDNA) into Xenophus eggs, that the transporter protein forms a sodium-dependent transmembrane ion channel that mediates the transport of silicic acid. The action of this protein can account for the uptake of the silica precursor from the dilute pool of silicic acid in oceanic and fresh water, and similar transporters may pump silicic acid (or its conjugates) into the lumen of the silica-deposition vesicle (silicalamella), in which polycondensaton (polymerization) is known to occur.

Kröger, et al., have cloned and characterized cDNAs encoding two families of protein (at least one of which is glycosylated) that contribute to the organic sheath surrounding the silica walls of a diatom [Kröger, N., Bergsdorf, C. and Sumper, M. (1994) EMBO J. 13, 4676-4683; and Kröger, N., Lehmann, G., Rachel, R. and Sumper, M. (1997) Eur. J. Biochem. 250, 99-105.]. The proteins most intimately associated with these silica walls contain regularly repeating hydroxyl-rich domains potentially capable of interacting with the growing silica structure [Hecky, R. E., Mopper, K., Kilham, P., & Degens, E. T. (1973) Mar. Biol. 19, 323-331; Swift, D. M. & Wheeler, A. P. (1992) Phycology 28, 209-213; and Harrison, C. C. (1996) Phytochemistry 41, 37-42]. Hecky et al. had proposed that such hydroxyl-rich domains might align silicic-acid monomers, either by condensing with them (with elimination of water) to form covalent adducts or by hydrogen bonding, thus bringing them into favorable juxtaposition for their condensation to form silica.

In contrast to anthropogenic and geological syntheses of these materials that require extremes of temperature, pressure or pH, living systems produce a remarkable diversity of nanostructured silicates at ambient temperatures and pressures and at near neutral pH. However, laboratory methods have been unable to replicate these results and rely instead on extreme pHs and/or surfactants to condense silica precursors into specific morphologies or patterned structures. These conditions are undesirable for environmental reasons and therefore methods to direct silica assembly under conditions similar to those used in nature (i.e. at low temperatures and neutral pH, with lower energy and capital costs) are desired.

### BRIEF SUMMARY OF THE INVENTION

The present invention overcomes the drawbacks of prior efforts to synthesize materials of silica, glass, and polymetallooxanes at low temperatures and neutral pH. The method of the present invention for synthesis of silica, silicone, glass, and polymetallo-oxane, comprises placing a reactant, wherein the reactant comprises a silicon alkoxide, metal alkoxide, silicon halide or metal halide, or organic conjugates of the foregoing, in a container or mold having at least one predetermined dimension, whereby to determine the shape of the silica, silicone, glass, or polymetallo-oxane; and adding an effective amount of a catalyst to the reactant to form silica, silicone, glass, or polymetallooxane materials at about neutral pH and at an ambient temperature. The predetermined dimension of the container or mold is microscopic, nanoscopic, or a combination thereof. Other molecules or materials can be added to either the container or the reactant so that the molecule or material that is added is coated with the resulting synthesized silica, silicone, glass, or polymetallooxane. A self-organizing structure including a self-assembling surfactant, vesicle, solid or hollow particle, or combinations thereof, is formed. Addition of the catalyst described below then polymerizes the molecule or material in this form, locking the structure in place. In another embodiment, a compatibilizing solvent including dimethylformamide or dimethylsulfoxide is added to the mixture prior to the addition of the catalyst.

The catalyst of the present invention comprises a compound having a nucleophilic functionality and a hydrogen-bonding acceptor group, whereby to assemble, hydrolyze, and condense the reactant at about neutral pH and at ambient temperature. A silicified structure synthesized according to the above method is also disclosed, the structure assuming a shape determined by the container or mold.

The present invention also discloses a composition for use in synthesizing silica, silicone, glass, or polymetallooxane, the composition comprising a silicon alkoxide, metal alkoxide, silicon halide or metal halide and a catalyst that assembles, hydrolyzes, and condenses the silicon alkoxide, metal alkoxide, silicon halide or metal halide at about neutral pH and at ambient temperature.

In yet another embodiment of the invention a bifunctional catalyst is disclosed wherein the catalyst comprises a compound having a nucleophilic functionality (such as, but not confined to —SH, —OH, etc.) and a hydrogen-bonding acceptor group (such as, but not confined to —NH, —NH₂, etc.), whereby to assemble, hydrolyze, and condense a reactant of a silicon alkoxide, metal alkoxide, silicon halide or metal halide at about neutral pH and at ambient temperature. The catalyst comprises such structures as Cysteamine, Hydroxylamine, Ethanolamine, Hydroxyalkylamines, and Mercaptoalkylamines.

Advantages of the invention over previously available technology include: (1) protection of acid-sensitive, alkali-sensitive, and heat-sensitive molecules, materials, objects or substances during the encapsulation or sealing process (in contrast to the exposure to acid, alkali, and/or heat required in present technologies; (2) the ability to rapidly coat, insulate, seal, encapsulate, package or sheath the sensitive materials and components itemized above, in either permeable or impermeable coatings of silica, glass or silicones with a wide range of physical (barrier and mechanical) properties, without their exposure to heat, and (3) the use of environmentally benign conditions for synthesis, with lower energy and capital costs than required by previously available technology.

The new catalysts and methods for their use described here make possible the synthesis of shape-controlled impermeable or semi-permeable coatings, membranes, sealants, encapsulants, insulators, polymers and materials of silica, glass, silicones and polymetallooxanes with unique advantages for the encapsulation and protection of sensitive materials and components at low temperatures and neutral pH, thus, without the requirement for exposure to any acid, alkali, or heat.

Potential applications include: coatings, sealants, insulators and encapsulants for a wide range of sensitive materials, including electronic, optoelectronic (photonic) circuits and components; medical implants and sensors; medical diagnostics based on immobilized or encapsulated enzymes, antibodies, living cells, receptors, hormones, and nucleic acids (DNA or RNA); sensors for chemical and biological toxic and infectious agents; foods; pharmaceuticals; biologicals; nutraceuticals; and cosmetics.

These and other features, aspects, and advantages of the present invention will become better understood with regard to the following detailed description and accompanying drawings.

### BRIEF DESCRIPTION OF THE DRAWINGS

FIGS. 1(a-c) illustrate the luminescence of the photoprotein Green Fluorescent Protein (GFP) encapsulated in a silica gel produced from the reactant tetraethoxysilane with or without the added catalyst. No polymerization occurred without a catalyst (FIG. 1a), whereas gels formed to encapsulate the luminescent protein when the catalysts ethanolamine (FIG. 1b) or cysteamine (FIG. 1c) were added.

FIGS. 2(a-c) illustrate the activity of the bioluminescence-producing enzyme luciferase encapsulated in a silica gel produced from the reactant tetraethoxysilane, with or without added catalyst. No polymerization occurred without catalyst (FIG. 2a), whereas gels formed under the influence of the catalysts ethanolamine (FIG. 2b) and cysteamine (FIG. 2c).

### DETAILED DESCRIPTION OF THE INVENTION

The catalysts of the present invention, include but are not confined to such structures as Cysteamine, Hydroxylamine, Hydroxyalkylamine, and Mercaptoalkylamines, and include both a nucleophilic functionality (such as, but not confined to —SH, —OH, etc.) and a hydrogen-bonding acceptor group (such as, but not confined to —NH, —NH₂, etc.). The catalysts mimic the in vivo activity of proteins that control silicification in marine organisms. For example, the marine sponge, Tethya aurantia, produces copious silica spicules (1-2 mm length×30 μm diameter) that constitute 75% of the dry weight of the organism. These spicules each contain a central axial filament of protein (1-2 mm length×2 μm diameter) consisting of three very similar subunits named silicateins (for silica proteins) [Shimizu, K., Cha, J., Stucky, G. D., & Morse, D. E. (1998) Proc. Natl. Acad. Sci. 95, 6234-6238]. These catalysts are highly efficacious in promoting the synthesis of silica, glass, silicones and polymetallo-oxanes.

Prior to the start of the synthesis reaction (generally, but not necessarily initiated by addition of the catalyst), the precursor solution or reactant mixture is placed in a container or mold (of microscopic, microscopic and/or nanoscopic dimensions) to determine the shape of the final product. Additional levels of structural control can be imposed by organization with self-assembling surfactants, block copolymers (for example, poly(L-Cysteine₁₀-b-L-Lysine₂₀₀), poly(L-Cysteine₃₀-b-L-Lysine₂₀₀), poly(L-Cysteine₆₀-b-L-Lysine₂₀₀), and poly(L-Cysteine₃₀-b-L-Lysine₄₀₀)), proteins, biological macromolecules, vesicles, solid or hollow particles, or other self-organizing molecules or structures, as desired.

The mold and the precursor solution or mixture also contain any molecules, materials, objects or substances to be coated, sealed or encapsulated by the resulting silica, glass, silicone or polymetallooxane. Addition of the catalyst (and mixing with the precursor solution or mixture) then initiates rapid synthesis of the corresponding silica, glass, silicone or polymetallo-oxane at neutral pH, without the requirement for any heating, and without the requirement for exposure to any acid, alkali, or caustic chemicals.[

### EXAMPLE

A reactant, including a silicon or metal alkoxide or halide (silicon or metal) (such as, tetraethoxysilane, also known as tetraethoxy-ortho-silicate), or organically substituted silicon or metal alkoxide or halide (such as, methyltriethoxysilane) is mixed with an effective amount (catalytic amount) of the catalyst (such as, a buffered aqueous solution of 0.1 M Cysteamine in 0.001 M tris-hydroxymethylaminomethane-HCl buffer at pH 7.0) with or without a compatibilizing solvent (such as, dimethylformamide or dimethylsulfoxide) to yield either one-phase or two-phase reaction mixtures, as desired. Volume ratios of [reactant]:[catalyst]:[solvent] are in the range of about [1.0]:[0.01-1.0]:[0-1.0]

After vigorous mixing of this composition, polymerization is allowed to proceed either with or without further mixing, templating, molding, hydrodynamic shear, extrusion, or other liquid-processing methods, with or without added dopants, dyes, lumiphores, fluorors, enzymes, antibodies, receptors, cells or other physical, chemical or biological inclusions, at low temperature and neutral pH, for times ranges from 10 minutes to 24 hours, until the desired gel or solid polymer network is formed. The final product may then be washed and dried, or maintained in various solvents, as appropriate for the specific application and compatible with the incorporated inclusions.

Results

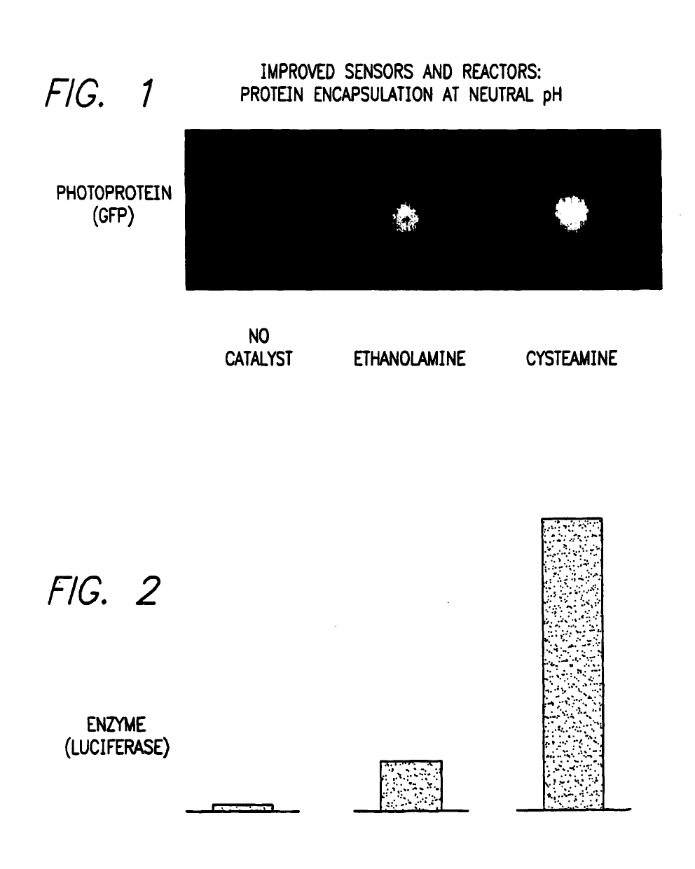

FIGS. 1(a-c) and FIGS. 2(a-c) illustrate the efficacy of two specific catalysts of the present invention. Specifically, FIGS. 1(a-c) illustrate the luminescence of the photoprotein Green Fluorescent Protein (GFP) incorporated in silica gels produced from the reactant tetraethoxysilane, no polymerization to form a gel occurred at neutral pH and low temperature in the control condition without a catalyst (FIG. 1a), accordingly, no fluorescent protein is evident. The luminescence of protein retained by progressively more cross-linked gels, which were formed under the influence of the catalysts Ethanolamine (FIG. 1b) and Cysteamine (FIG. 1c), was seen also at neutral pH and low temperature.

FIGS. 2(a-c) illustrate the activity of the bioluminescence-producing enzyme, luciferase, incorporated in silica gels produced from the reactant tetraethoxysilane, no polymerization to form a gel occurred at neutral pH and low temperature in the control condition without catalyst (FIG. 2a); accordingly, no enzyme was retained, and no luminescence was produced upon addition of the substrate (luciferin), retention of enzyme and production of light from luciferin, by progressively more cross-linked gels formed under the influence of the catalysts Ethanolamine (FIG. 2b) and Cysteamine (FIG. 2c) under the same conditions.

Although the foregoing invention has been described in detail by way of illustration for purposes of clarity and understanding, various modifications and changes which are within the knowledge of those skilled in the art are considered to fall within the scope of the appended claims.

The following references are incorporated herein by reference: Auner, N. and Weis., J. (1998) Organosilicon Chemistry III: From Molecules to Materials, Wiley W C H; Auner, N. and Weis., J. Organosilicon Chemistry IV: From Molecules to Materials, Wiley W C H (in press); and Ball, P. (1997) Made to Measure: New Materials for the 21^{st} Century, Princeton University Press, Princeton, N.J., USA; Simpson, T. L. and Volcani, B. E. (1981) Silicon and Siliceous Structures in Biological Systems, Springer-Verlag; Voronkov, M. G., Zelchan, G. I. and Lukevits, E. J. (1997) Silicon and Life (2^{nd} ed.), Zinatne Publishing, Vilnius, Lithuania; Hildebrand, M., Volcani, B. E., Gassman, W., & Schroeder, J. I. (1997) Nature 385, 688-689; .Kröger, N., Bergsdorf, C. and Sumper, M. (1994) EMBO J. 13, 4676-4683; Kröger, N., Lehmann, G., Rachel, R. and Sumper, M. (1997) Eur. J. Biochem. 250, 99-105; Hecky, R. E., Mopper, K., Kilham, P., & Degens, E. T. (1973) Mar. Biol. 19, 323-331; Swift, D. M. & Wheeler, A. P. (1992) Phycology 28, 209-213; Harrison, C. C. (1996) Phytochemistry 41, 37-42; Shimizu, K., Cha, J., Stucky, G. D., & Morse, D. E. (1998) Proc. Nat. Acad. Sci. 95, 6234-6238; and International Application No. PCT/US99/30601 filed Dec. 18, 1999.

1. A method for synthesis of silica, silicone, glass, and polymetallooxane, comprising:
(a) placing a reactant, wherein the reactant comprises a silicon alkoxide, metal alkoxide, silicon halide or metal halide, or organic conjugates of the foregoing, in a container having at least one predetermined dimension, whereby to determine the shape of the silica, silicone, glass, or polymetallooxane; and
(b) adding an effective amount of a catalyst to the reactant to form silica, silicone, glass, or polymetallooxane materials at about neutral pH and at an ambient temperature.

2. The method of claim 1, wherein the predetermined dimension of said container is microscopic, nanoscopic, or combinations thereof.

3. The method of claim 1, further comprising adding to either the container or the reactant, a molecule or material, whereby to coat the molecule or material with the resulting synthesized silica, silicone, glass, or polymetallooxane.

4. The method of claim 1, further comprising adding a self-organizing structure including a self-assembling surfactant, vesicle, solid or hollow particle, or combinations thereof, to the reactant.

5. The method of claim 1, further comprising vigorously mixing the catalyst and the reactant.

6. The method of claim 1, further comprising adding a compatibilizing solvent including dimethylformamide or dimethylsulfoxide to the reactant prior to the addition of the catalyst.

7. The method of claim 6, wherein the volume ratio of the reactant:catalyst:solvent is in the range of about 1.0:0.01-1.0:0-1.0.

8. The method of claim 1, wherein the reactant is tetraethoxysilane or methyltriethoxysilane.

9. The method of claim 1, wherein the catalyst comprises a compound having a nucleophilic functionality and a hydrogen-bonding acceptor group, whereby to assemble, hydrolyze, and condense the reactant at about neutral pH and at ambient temperature.

10. The method of claim 1, wherein the catalyst comprises cysteamine, hydroxylamine, hyddroxyalkylamine, or mercaptoalkylamine.

11. A composition for use in synthesizing silica, silicone, glass, or polymetallooxane, said composition comprising a silicon alkoxide, metal alkoxide, silicon halide or metal halide and a catalyst that assembles, hydrolyzes, and condenses the silicon alkoxide, metal alkoxide, silicon halide or metal halide at about neutral pH and at ambient temperature.

12. A bifunctional catalyst wherein the catalyst comprises a compound having a nucleophilic functionality and a hydrogen-bonding acceptor group, whereby to assemble, hydrolyze, and condense a reactant of a silicon alkoxide, metal alkoxide, or silicon halide or metal halide at about neutral pH and at ambient temperature.

13. The bifunctional catalyst of claim 12, wherein the catalyst comprises cysteamine, hydroxylamine, hyddroxyalkylamine, or mercaptoalkylamine.

14. A silicified structure synthesized according to the method of claim 1, said structure assuming a shape determined by the container.

15. A silicified structure synthesized according to the method of claim 4, said structure assuming a shape of said self-organizing structure.
